(19) United States
(12) Patent Application Publication
(10) Pub. No.: US 2012/0032887 A1
(43) Pub. Date: Feb. 9, 2012

(54) TOUCH KEYBOARD AND ELECTRONIC DEVICE

(75) Inventors: Chia-Jung Chiu, Hsin-Chu (TW); Chih-Jen Tsang, Hsin-Chu (TW)

(73) Assignee: YOUNG LIGHTING TECHNOLOGY CORPORATION, Hsin-Chu (TW)

(21) Appl. No.: 13/191,493

(22) Filed: Jul. 27, 2011

(30) Foreign Application Priority Data
Aug. 5, 2010 (TW) 99126117

(51) Int. Cl. G06F 3/02

(52) U.S. Cl. 345/168

(57) ABSTRACT

A touch keyboard including a keyboard pattern and a touch module is provided. A sensing space is located in front of the keyboard pattern. The touch module is disposed at periphery of the keyboard pattern. The touch module includes a light-emitting element, a light guide unit, and an optical detector. The light-emitting element is disposed beside the keyboard pattern and capable of emitting a light beam. The light guide unit is disposed at a side of the keyboard pattern and has a first surface, a second surface, and a light incident surface. The light beam from the light-emitting element is capable of entering the light guide unit through the light incident surface and capable of being transmitted to the sensing space through the first surface. The optical detector is disposed beside the sensing space for sensing the light beam from the sensing space. An electronic device is also provided.

### CROSS-REFERENCE TO RELATED APPLICATION

This application claims the priority benefit of Taiwan application serial no. 99126117, filed on Aug. 5, 2010. The entirety of the above-mentioned patent application is hereby incorporated by reference herein and made a part of this specification.

### BACKGROUND

1. Field of the Invention

The invention relates to a keyboard and an electronic device using the same. Particularly, the invention relates to a touch keyboard and an electronic device using the same.

2. Description of Related Art

With the coming era of information explosion, efficiency for processing and providing information becomes essential. In this case, a good keyboard design may avail improving the efficiency for processing and providing information.

To improve the efficiency, a number of keys of the keyboard of a computer or a notebook computer is up to about 100, and different key position configurations are designed to satisfy habits of different users, language habits of different nations, and utilization requirements of different usages. For example, a key number of a Japanese standard keyboard is more than that of an American standard keyboard, and configuration positions of the keys are also different. Since a conventional computer keyboard is a physical keyboard, a manufacturer generally manufactures different keyboards to satisfy habits of different users, language habits of different nations, and utilization requirements of different usages. Once such kind of keyboard is manufactured, it cannot be changed to other keyboard configurations, which is inconvenient in inventory management. Moreover, a user generally selects a favorite keyboard configuration when purchasing a keyboard, and once the keyboard is purchased, the keyboard configuration cannot be changed. Such problem is more obvious for a notebook computer. For example, if the user considers that the keyboard configuration does not match his utilization habit after purchasing the notebook computer, the user has to replace the notebook computer in order to thoroughly resolve such problem, though it is quite impracticable. Moreover, if the notebook computers using the American standard keyboards are sold to Japan, a sales volume thereof is influenced due to that the keyboard configuration does not match the Japanese utilization habit.

Moreover, since the conventional keyboard applies physical keys, limited by heights of the keys, a thickness of the conventional keyboard is hard to be effectively reduced, so that a thickness of the notebook computer is hard to be reduced. In addition, since external liquid is easy to infiltrate the keyboard from fissures between the physical keys to short-circuit a circuit board therein, a waterproof function of the conventional keyboard is hard to be implemented.

Keyboards disclosed by U.S. Patent Publication Nos. 20080225006 and 20100103116, a Taiwan Patent No. 1236239 and a Taiwan Patent Publication No. 200816023 are all physical keyboards. Keyboards disclosed by U.S. Pat. Nos. 6,510,048 and 7,719,826 are detachable. Taiwan Patent No. M358363, a Taiwan Patent Publication No. 200943139, U.S. Pat. Nos. 6,844,539, 7,355,594, and 7,573,465 and U.S. Patent Publication No. 20030234346 and 20100090986 respectively disclose a touch device.

### SUMMARY OF THE INVENTION

The invention is directed to a touch keyboard, the touch keyboard has a thin thickness and a light weight.

The invention is directed to an electronic device, the electronic device has a thin thickness and a light weight.

Additional aspects and advantages of the invention will be set forth in the description of the techniques disclosed in the invention.

To achieve one of or all aforementioned and other advantages, an embodiment of the invention provides a touch keyboard including a keyboard pattern and a touch module. A sensing space is located in front of the keyboard pattern. The touch module is disposed at periphery of the keyboard pattern. The touch module includes at least one light emitting element, at least one light guide unit, and at least one optical detector. The light emitting element is disposed beside the keyboard pattern and capable of emitting a light beam. The light guide unit is disposed at a side of the keyboard pattern. The light guide unit has a first surface, a second surface opposite to the first surface, and a light incident surface connected to the first surface and the second surface. The light beam from the light emitting element is capable of entering the light guide unit through the light incident surface and capable of being transmitted to the sensing space through the first surface. The optical detector is disposed beside the sensing space for sensing the light beam from the sensing space.

Another embodiment of the invention provides an electronic device including a screen, a base, and the aforementioned touch keyboard. The screen has a display area, and the display area is capable of displaying a dynamic image frame. The base is connected to the screen, and the touch keyboard is disposed on the base.

The embodiments of the invention may achieve at least one of the following effects. The touch keyboard and the electronic device according to the embodiments of the invention may use the optical detector to detect a touch operation of a user, so that a thickness of the touch keyboard is relatively thin, and a weight thereof is relatively light. Accordingly, the electronic device according to the embodiment of the invention may have a small size and a light weight.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional view of an electronic device according to an embodiment of the invention.

FIG. 1B is an exploded view of an electronic device of FIG. 1A.

FIG. 2A is a three-dimensional view of a carrier board, a light emitting device, a light guide unit, and a reflection unit of FIG. 1B.

FIG. 2B is an enlarged view of a region R of FIG. 2A.

FIG. 3 is a cross-sectional view of a carrier board and a light guide unit of FIG. 1B along an I-I line.

FIG. 4 is a front view of a touch module and a keyboard pattern of FIG. 1B.

FIG. 5 is a block diagram of a touch module of FIG. 1A.

FIG. 6 is an operation flowchart of a control unit.

FIG. 7 is an exploded view of an electronic device according to another embodiment of the invention.

FIG. 8 is a three-dimensional view of a reversed touch keyboard of FIG. 7.

FIG. 9 is a cross-sectional view of a touch keyboard of FIG. 7 along an II-II line.

FIG. 10 is a three-dimensional view of an electronic device according to still another embodiment of the invention.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

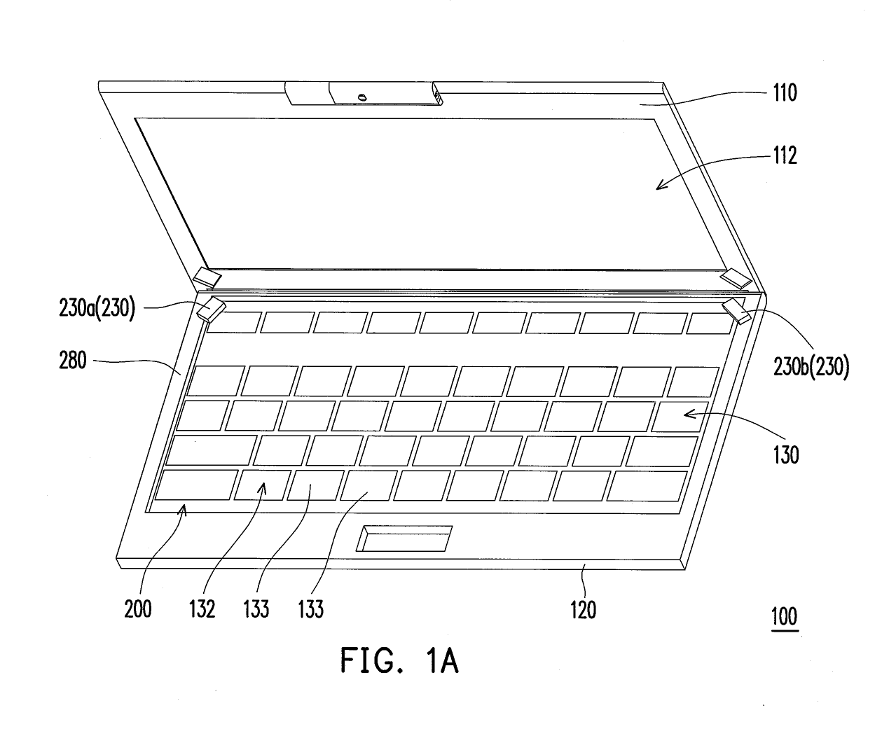

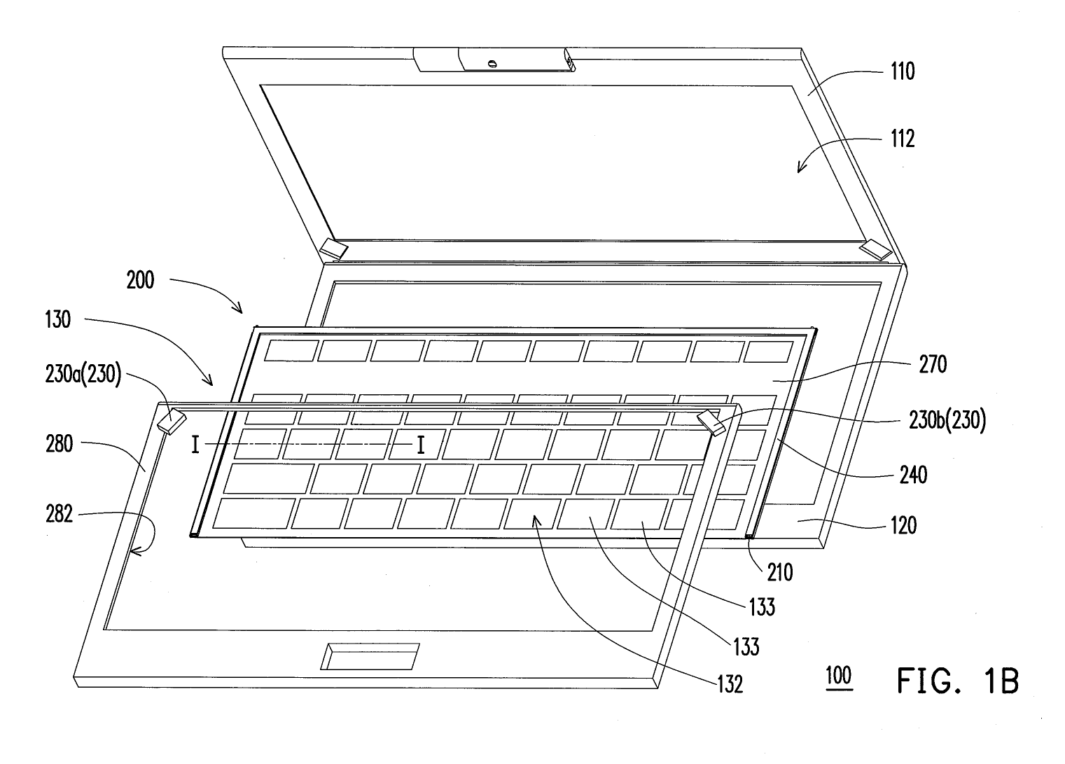

FIG. 1A is a three-dimensional view of an electronic device according to an embodiment of the invention, and FIG. 1B is an exploded view of the electronic device of FIG. 1A. Referring to FIG. 1A and FIG. 1B, the electronic device 100 of the embodiment is, for example, a notebook computer. The electronic device 100 includes a screen 110, a base 120, and a touch keyboard 130. The screen 110 has a display area 112, and the display area 112 is capable of displaying a dynamic image frame. The base 120 is connected to the screen 110, and the touch keyboard 130 is disposed on the base 120.

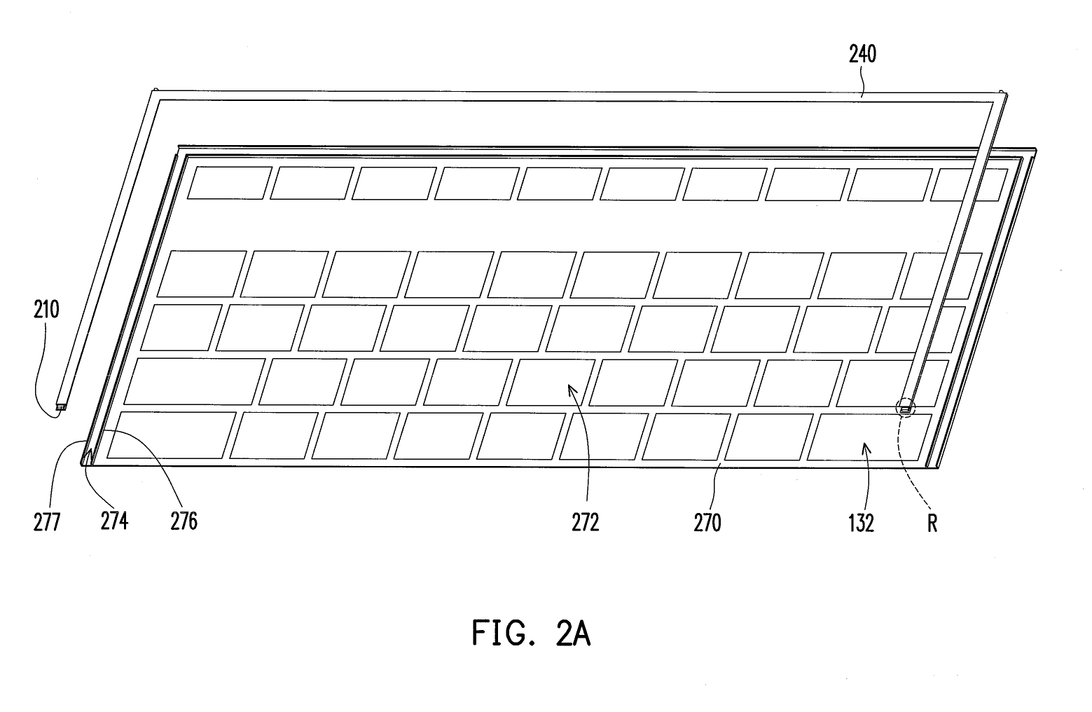

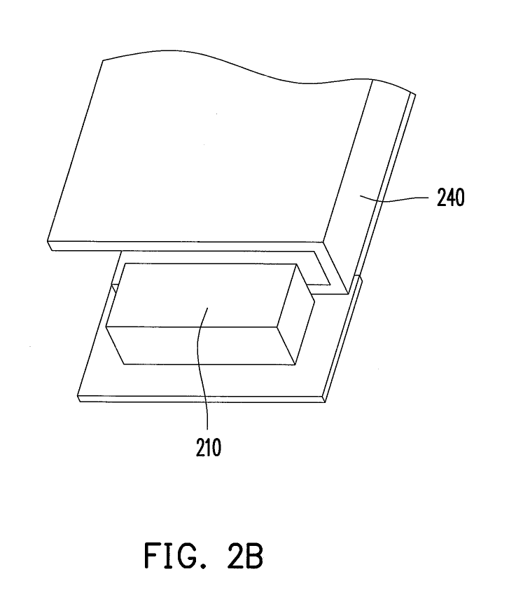

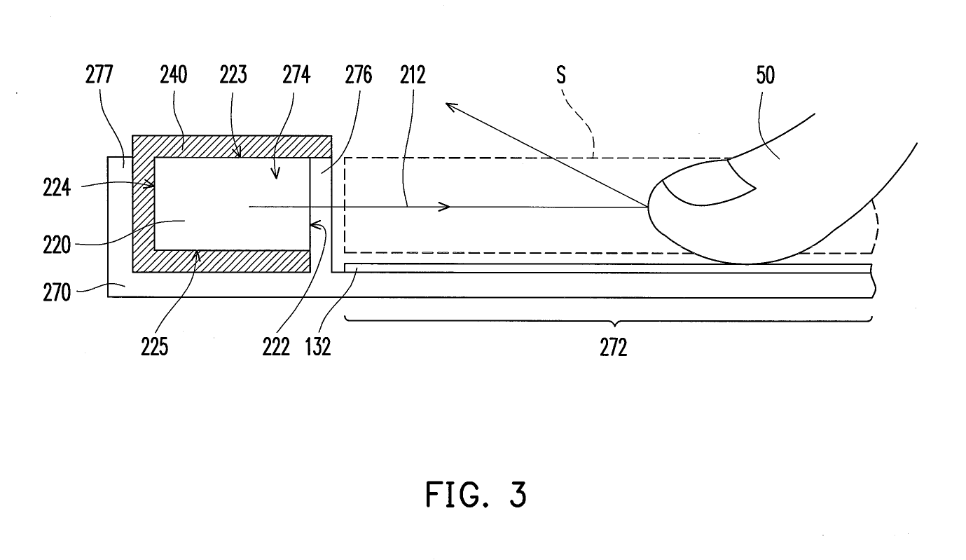

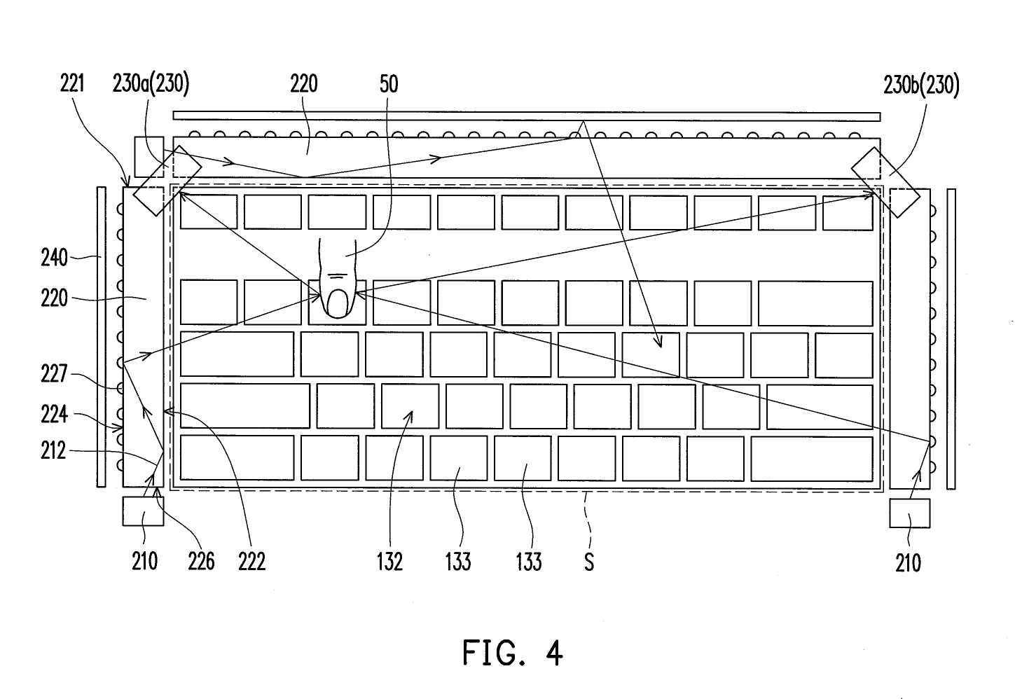

FIG. 2A is a three-dimensional view of a carrier board, a light emitting device, a light guide unit, and a reflection unit of FIG. 1B, FIG. 2B is an enlarged view of a region R of FIG. 2A, FIG. 3 is a cross-sectional view of the carrier board and the light guide unit of FIG. 1B along an I-I line, and FIG. 4 is a front view of a touch module and a keyboard pattern of FIG. 1B. Referring to FIG. 1A, FIG. 1B, FIG. 2A, FIG. 2B, FIG. 3, and FIG. 4, the touch keyboard 130 includes a keyboard pattern 132 and a touch module 200. A sensing space S is located in front of the keyboard pattern 132 (shown in FIG. 3 and FIG. 4). The touch module 200 is disposed at periphery of the keyboard pattern 132. Moreover, the keyboard pattern 132 includes a plurality of key patterns 133. In the embodiment, the key patterns 133, for example, form a keyboard having English letters, numbers, and symbols. However, in other embodiments, the key patterns 133 may also form a numeric keyboard, a keyboard capable of inputting languages of other nations or multi languages, or form other different types or styles of keyboard. The touch module 200 includes at least one light emitting element 210 (in the embodiment, three light emitting elements 210 are taken as an example), at least one light guide unit 220 (in the embodiment, three light guide units 220 are taken as an example), and at least one optical detector 230 (in the embodiment, two optical detectors 230a and 230b are taken as an example). The light emitting element 210 is disposed beside the keyboard pattern 132 and is capable of emitting a light beam 212. In the embodiment, the light emitting element 210 is, for example, an infrared light-emitting diode (IR-LED), and the light beam 212 is, for example, an infrared beam. However, in other embodiments, the light emitting element 210 may also be a light emitter or an electromagnetic wave emitter capable of emitting visible light or electromagnetic waves of other wavelengths. The light guide unit 220 is disposed at a side of the keyboard pattern 132. The light guide unit 220 has a first surface 222, a second surface 224 opposite to the first surface 222, and a light incident surface 226 connected to the first surface 222 and the second surface 224. The light beam 212 from the light emitting element 210 is capable of entering the light guide unit 220 through the light incident surface 226, and is capable of being transmitted to the sensing space S through the first surface 222.

In the embodiment, the light guide unit 220 further has a third surface 221 (shown in FIG. 4), a fourth surface 223, and a fifth surface 225 (shown in FIG. 3). The third surface 221 is opposite to the light incident surface 226, and is connected to the first surface 222 and the second surface 224. The fourth surface 223 is connected to the third surface 221 and the light incident surface 226, and is connected to the first surface 222 and the second surface 224. The fifth surface 225 is opposite to the fourth surface 223, and the fifth surface 225 is connected to the third surface 221 and the light incident surface 226, and is connected to the first surface 222 and the second surface 224. In other words, the light guide unit 220 is, for example, a light guide bar. In the embodiment, the touch module 200 further includes at least one reflection unit 240, the reflection unit 240 is disposed on at least one of the second surface 224, the third surface 221, the fourth surface 223, and the fifth surface 225, and a bended reflection unit 240 disposed on the second surface 224, the fourth surface 223, and the fifth surface 225 is illustrated in FIG. 3 as an example.

When the light beam 212 from the light emitting element 210 enters the light guide unit 220, the light beam 212 is capable of being totally reflected by the first surface 222, the second surface 224, the fourth surface 223, and the fifth surface 225, and is confined within the light guide unit 220. However, light scattering microstructures 227 disposed on the surface of the light guide unit 220 spoil the total reflection, and scatter the light beam 212 to the first surface 222, so that the light beam 212 is transmitted to the sensing space S through the first surface 222. Alternatively, the light scattering microstructures 227 may also scatter the light beam 212 to the reflection unit 240, and the reflection unit 240 may reflect the light beam 212 to the first surface 222, so that the light beam 212 is transmitted to the sensing space S through the first surface 222. In this way, the light beam 212 from the light guide unit 220 may be evenly transmitted to the sensing space S. In the embodiment, the light scattering microstructures 227 are, for example, disposed on the second surface 224. However, in other embodiments, the light scattering microstructures 227 may also be disposed on at least one of the first surface 222, the second surface 224, the third surface 221, the fourth surface 223, and the fifth surface 225.

The optical detectors 230 are disposed beside the sensing space S for sensing the light beam 212 from the sensing space S. In the embodiment, the optical detectors 230 are, for example, complementary metal oxide semiconductor sensors (CMOS sensors), charge coupled devices (CCDs) or other suitable optical detectors. When an object 50 (for example, user's finger or a stylus) enters the sensing space S and approaches the keyboard pattern 132, the object 50 may reflect a part of the light beam 212 in the sensing space S to the optical detectors 230 (for example, the optical detectors 230a and 230b in the embodiment). Then, the touch module 200 of the embodiment may determine a position of the object 50 relative to the keyboard pattern 132 according to images detected by the optical sensors 230, so as to determine the key pattern 133 where the object 50 is located, and accordingly output a signal corresponding to the key pattern 133.

In the embodiment, the touch keyboard 130 includes a carrier board 270, and the carrier board 270 includes a keyboard area 272 and a notch 274. The keyboard pattern 132 is disposed on the keyboard area 272, and the notch 274 is disposed at an edge of the keyboard area 272, wherein the light emitting element 210 and the light guide unit 220 are disposed in the notch 274. In the embodiment, the notch 274 is formed between a protrusion 276 and a protrusion 277 protruded out from the carrier board 270, wherein the light beam 212 emitted from the first surface 222 may penetrate through the protrusion 276 and enter the sensing space S. In the embodiment, a material of the protrusion 276 is, for example, a material pervious to infrared light.

In the embodiment, the touch keyboard 130 further includes a top cover 280. The top cover 280 has an opening 282, and the top cover 280 covers the notch 274, the light emitting element 210, and the light guide unit 220. The opening 282 exposes the keyboard pattern 132. Moreover, the carrier board 270 and the top cover 280 are disposed on the base 120.

In the embodiment, the keyboard pattern 132 is, for example, a thin film printed with a pattern. For example, the thin film is disposed on the keyboard area 272 of the carrier board 270, and is attached to the keyboard area 272. For example, the thin film is attached to the keyboard area 272 through an in-mold roller (IMR) technique, adhesive mounting or other suitable methods. However, in other embodiments, the keyboard pattern 132 may also be a patterned printed layer, i.e. the keyboard pattern 132 may be directly printed on the keyboard area 272. Moreover, in the embodiment, the keyboard pattern 132 is disposed at a position outside the display area 112, i.e. a position outside the dynamic image frame.

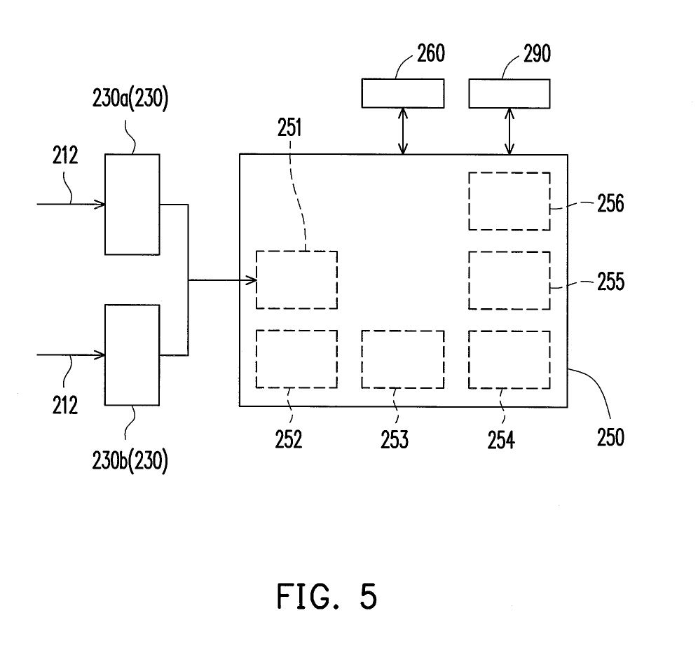

FIG. 5 is a block diagram of the touch module of FIG. 1A. Referring to FIG. 1B, FIG. 4 and FIG. 5, in the embodiment, the touch keyboard 200 further includes a control unit 250 and a memory unit 260. The control unit 250 is electrically connected to the optical detectors 230, wherein the control unit 250 determines the position of the object 50 entering the sensing space S according to the signals transmitted from the optical detectors 230. In the embodiment, the control unit 250 is, for example, a digital signal processor (DSP). Moreover, in the embodiment, the control unit 250 further includes a sensor interface 251, an image processing unit 252, a general purpose input output (GPIO) interface 253, a universal serial bus (USB) interface 254, a micro control unit (MCU) 255, and a memory control unit 256. The signals from the optical detectors 230 may be transmitted to internal of the control unit 250 through the sensor interface 251 for processing.

The memory unit 260 is electrically connected to the control unit 250. The memory unit 260 stores position information corresponding to the key patterns 133, and the control unit 250 determines the key pattern 133 touched by the object 50 according to the position information. In detail, after the keyboard pattern 132 disposed on the keyboard area 272 is determined, a position of the keyboard pattern 132 may be calibrated. In other words, a relationship between coordinates of a position touched by the object 50 and the key pattern 133 pressed by the object is determined, so as to form the position information, and such position information is stored in the memory unit 260. In the embodiment, the memory unit 260 is, for example, a flash memory or other suitable memories. When the touch keyboard 130 is manufactured, as long as the memory unit 260 storing the position information is electrically connected to the control unit 250, the touch keyboard 130 may be normally used. Moreover, when a user or a manufacturer wants to change a keyboard configuration, another keyboard pattern 132 may be attached to the keyboard area 272, and the memory unit 260 storing the position information corresponding to such keyboard pattern 132 is used, so as to change the keyboard configuration. Therefore, it is unnecessary to purchase or manufacture a new keyboard.

Moreover, in the embodiment, a memory 290 may be electrically connected to the memory control unit 256. The memory 290 is, for example, a random access memory (RAM), the memory 290 may store information required to be stored during a computation process of the control unit 250. In addition, in the embodiment, when the control unit 250 determines the key pattern 133 touched by the object 50 according to the position information, the control unit 250 may output a signal corresponding to the key pattern 133 to a processor (for example, a central processing unit (CPU)) of the electronic device 100 through the USB interface 254. However, in other embodiments, the control unit 250 may also output the signal corresponding to the key pattern 133 to the processor of the electronic device 100 through other interfaces. Moreover, in other embodiments, the MCU 255 may be used to electrically connect the optical detectors 230 for processing the signals from the optical detectors 230 without using a digital signal processor.

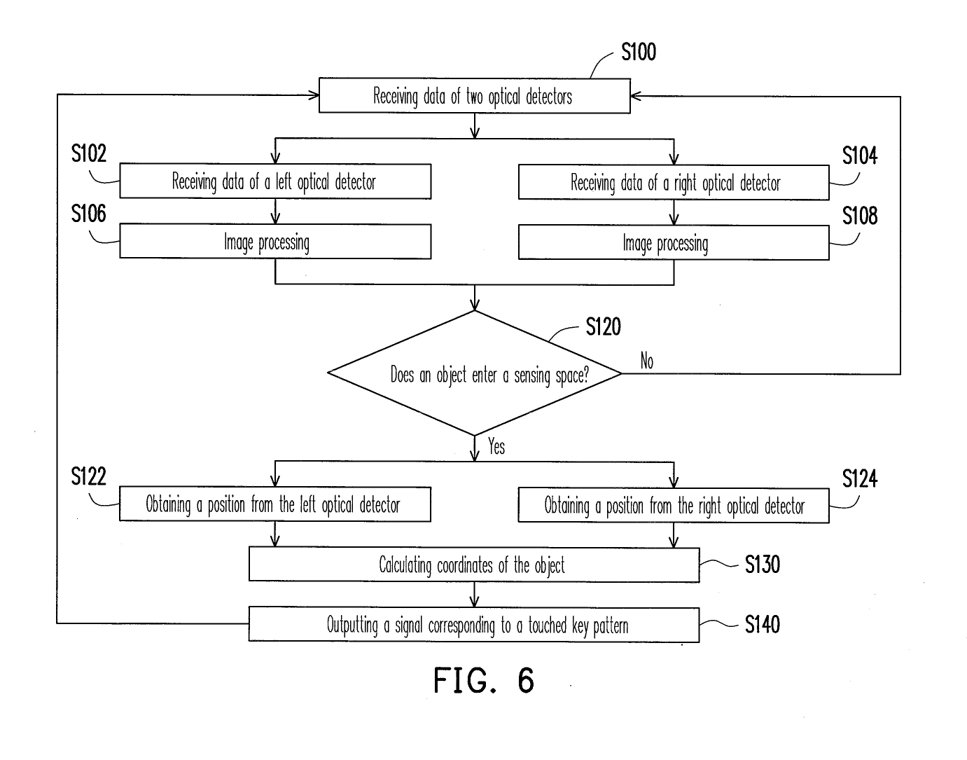

FIG. 6 is an operation flowchart of the control unit. Referring to FIG. 4, FIG. 5, and FIG. 6, the control unit 250 first executes a step S100, i.e. receives data transmitted from the optical detectors 230a and 230b. Then, the control unit 250 executes steps S102 and S104, and in the step S102, data of the optical detector 230a is obtained, and in the step S104, data of the optical detector 230b is obtained. Then, the control unit 250 executes a step S106 to perform image processing to the data received from the optical detector 230a, and the control unit 250 executes a step S108 to perform image processing to the data received from the optical detector 230b. The image processing includes reducing a background brightness, adjusting a threshold or performing equalization. Next, results of the steps S106 and S108 are synthesized to execute a step S120, so as to determine whether the object 50 enters the sensing space S. If not, the step S100 is repeated, and if the object 50 enters the sensing space S, steps S122 and S124 are executed. In the step S122, a position of the object 50 is obtained through the optical detector 230a, and in the step S124, the position of the object 50 is obtained through the optical detector 230b. Then, the control unit 250 executes a step S130, by which results of the steps S122 and S124 are synthesized to calculate the coordinates of the object 50. In the embodiment, since data transmitted by two optical detectors 230a and 230b are used, two-dimensional coordinates of the object 50 may be calculated. Then, such two-dimensional coordinates are compared to the position information stored in the memory unit 260, so as to determine the key pattern 133 touched by the object 50. Then, a step S140 is executed, by which a signal corresponding to the key pattern 133 touched by the object 50 is output. Then, the step S100 is repeated to repeatedly detect a position variation of the object 50.

Since the touch keyboard 130 and the electronic device 100 of the embodiment apply the optical detectors 230 to detect a touch operation of the user, a thickness of the touch keyboard 130 is relatively thin, and a weight thereof is relatively light. In detail, since the touch keyboard 130 applies the keyboard pattern 132 (for example, the aforementioned thin film or printed layer) other than physical keys, the thickness of the touch keyboard 130 is relatively thin, and the weight thereof is relatively light. Therefore, a thickness of the electronic device 100 using the touch keyboard 130 is relatively thin, and the weight thereof is relatively light. Moreover, compared to the physical keys having a problem that external liquid is easy to infiltrate to internal of the keyboard from fissures between the physical keys to short-circuit a circuit board therein, the touch keyboard 130 applying the keyboard pattern 132 (for example, the aforementioned thin film or printed layer) does not have such problem, so that a waterproof function is achieved.

It should be noticed that although two optical detectors 230a and 230b are taken as an example in the embodiment, in other embodiments, a number of the optical detectors 230 may be three or more, or only one. Moreover, in the embodiment, although a situation that the two optical detectors 230a and 230b are respectively disposed at a top left corner and a top right corner of the keyboard pattern 132 is taken as an example, in other embodiments, the optical detectors 230a and 230b may also be respectively disposed at a bottom left corner and the top right corner of the keyboard pattern 132, or other positions. In addition, in the embodiment, the light guide units 220 are respectively disposed at a left side, an upside, and a right side of the keyboard pattern 132, though in other embodiments, the light guide units 220 may be respectively disposed at the left side, a downside, and the right side of the keyboard pattern 132, or other positions. In the embodiment, the control unit 250 determines a position of the object 50 according to reflected light of the object 50 detected by the optical detectors 230, i.e. determines the position of the object 50 according to detected bright spots. However, in other embodiments, the control unit 250 may also determine a position of the object 50 according to dark spots detected by the optical detectors 230, wherein the dark spots are generated due to that the object 50 shields the backlight.

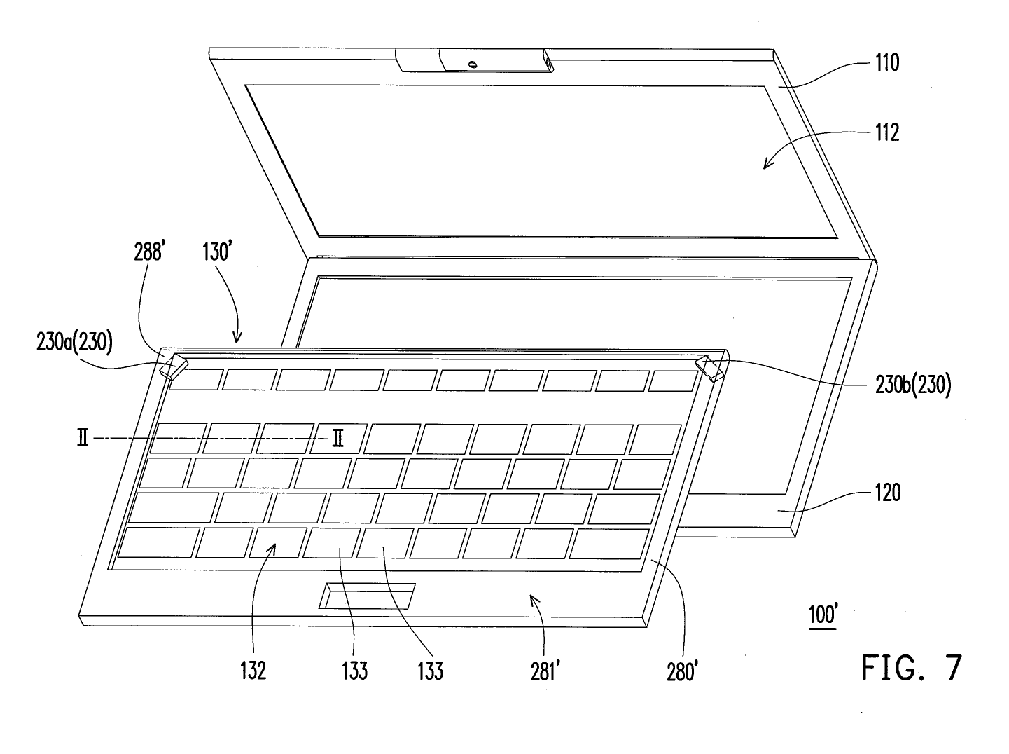

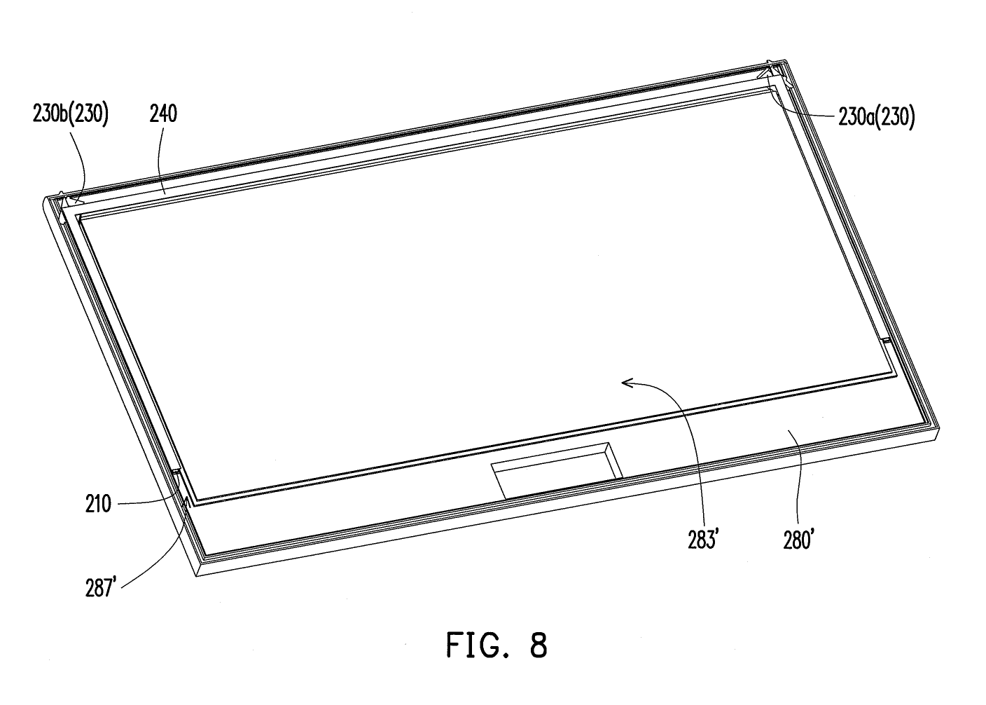

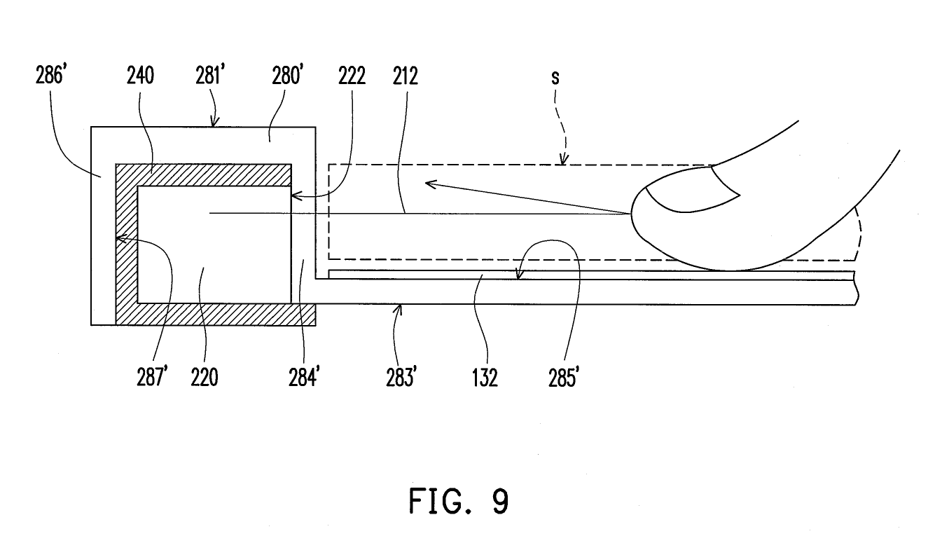

FIG. 7 is an exploded view of an electronic device according to another embodiment of the invention, FIG. 8 is a three-dimensional view of a reversed touch keyboard of FIG. 7, and FIG. 9 is a cross-sectional view of a touch keyboard of FIG. 7 along an II-II line. Referring to FIGS. 7-9, the electronic device 100′ of the embodiment is similar to the electronic device 100 of FIG. 1A, and differences therebetween are as follows. In the electronic device 100′ of the embodiment, the carrier board 270 and the top cover 280 of the electronic device 100 are integrated to form a top cover 280′ shown in FIGS. 7-9. In detail, in the present embodiment, the top cover 280′ includes an upper surface 281′, a lower surface 283′, a recessed area 285′, and a notch 287′. The lower surface 283′ is opposite to the upper surface 281′. The recessed area 285′ is disposed on the upper surface 281′, wherein the keyboard pattern 132 is disposed in the recessed area 285′. The notch 287′ is disposed on the lower surface 283′, and is located around the recessed area 285′. The light emitting element 210 and the light guide unit 220 are disposed in the notch 287′, the top cover 280′ covers the base 120, and the lower surface 283′ faces to the base 120. In the embodiment, the notch 287′ may be formed between a sidewall 284′ and a sidewall 286′, and the light beam 212 emitted from the first surface 222 may penetrate through the sidewall 284′ and enter the sensing space S.

In FIG. 1A, the optical detectors 230 are disposed on the top cover 280, though in the embodiment, the optical detectors 230 are disposed in internal of a frame 288′ of the top cover 280′.

The electronic device 100′ and the touch keyboard 130′ of the embodiment also have relatively thin thickness and light weight, and have a waterproof function.

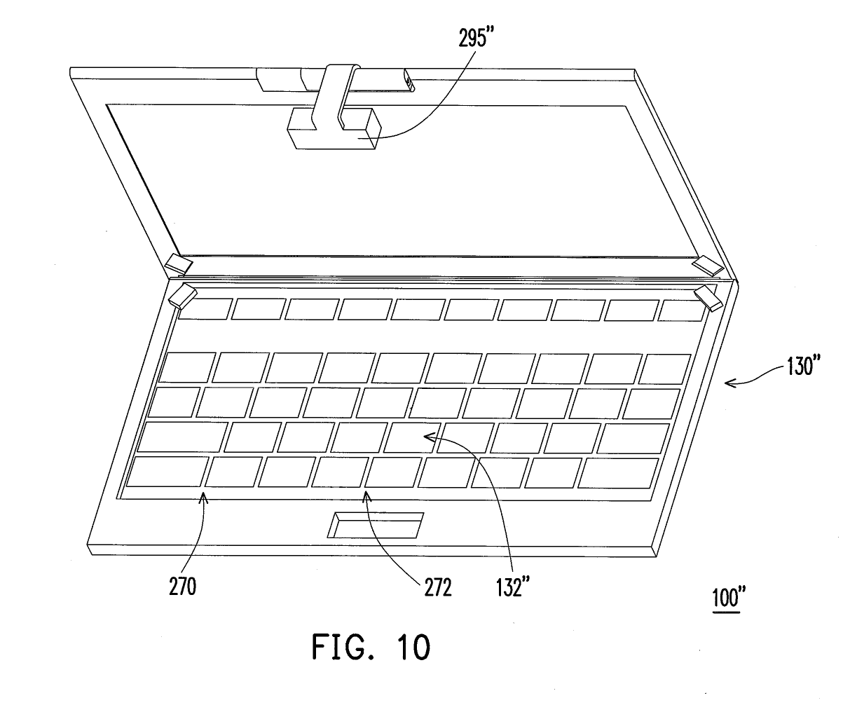

FIG. 10 is a three-dimensional view of an electronic device according to still another embodiment of the invention. Referring to FIG. 10, the electronic device 100″ of the embodiment is similar to the electronic device 100 of FIG. 1A, and differences therebetween are as follows. In the embodiment, a touch keyboard 130″ of the electronic device 100″ further includes a projection module 295″, and a keyboard pattern 132″ is an image projected by the projection module 295″, i.e. an image projected by the projection module 295″ on the keyboard area 272 of the carrier board 270.

It should be noticed that the aforementioned touch keyboard 130, 130′ or 130″ is not limited to be used in a notebook computer, and since a size thereof is not limited, the touch keyboard may also be applied to mobile phones, personal digital assistants (PDAs), digital cameras or other electronic devices. Moreover, the aforementioned touch keyboard 130, 130′ or 130″ may also be an independent external keyboard. Namely, after the base 120 of the electronic device is changed to a base of the touch keyboard 130, 130′ or 130″, the touch keyboard 130, 130′ or 130″ may be an independent keyboard, the independent keyboard may be connected to a computer host or other electronic devices through a cable, or may be connected to the computer host or the other electronic devices through a wireless transmission module.

In summary, the embodiments of the invention may achieve at least one of the following effects. The touch keyboard and the electronic device according to the embodiments of the invention use the optical detector to detect a touch operation of the user, so that a thickness of the touch keyboard is relatively thin, and a weight thereof is relatively light. Accordingly, the electronic device according to the embodiments of the invention may have a small size and a light weight.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch keyboard, comprising:
a keyboard pattern, wherein a sensing space is located in front of the keyboard pattern; and
a touch module, disposed at periphery of the keyboard pattern, and comprising:
at least one light emitting element, disposed beside the keyboard pattern, capable of emitting a light beam;
at least one light guide unit, disposed at a side of the keyboard pattern and having a first surface, a second surface opposite to the first surface, and a light incident surface connected to the first surface and the second surface, wherein the light beam from the light emitting element is capable of entering the light guide unit through the light incident surface and capable of being transmitted to the sensing space through the first surface; and
at least one optical detector, disposed beside the sensing space for sensing the light beam from the sensing space.

2. The touch keyboard as claimed in claim 1, further comprising a carrier board, the carrier board comprising:
a keyboard area, wherein the keyboard pattern is disposed on the keyboard area; and
a notch, disposed at an edge of the keyboard area, wherein the light emitting element and the light guide unit are disposed in the notch.

3. The touch keyboard as claimed in claim 2, further comprising a top cover having an opening, wherein the top cover covers the notch, the light emitting element, and the light guide unit, and the opening exposes the keyboard pattern.

4. The touch keyboard as claimed in claim 1, further comprising a top cover comprising:
an upper surface;
a lower surface, opposite to the upper surface;
a recessed area, disposed on the upper surface, wherein the keyboard pattern is disposed in the recessed area; and
a notch, disposed on the lower surface, wherein the light emitting device and the light guide unit are disposed in the notch.

5. The touch keyboard as claimed in claim 1, wherein the keyboard pattern is a patterned printed layer.

6. The touch keyboard as claimed in claim 1, wherein the keyboard pattern is a thin film printed with a pattern.

7. The touch keyboard as claimed in claim 1, further comprising a projection module, wherein the keyboard pattern is an image projected by the projection module.

8. The touch keyboard as claimed in claim 1, wherein the keyboard pattern is disposed at a position outside a dynamic image frame.

9. The touch keyboard as claimed in claim 1, wherein the light guide unit further comprises:
a third surface, opposite to the light incident surface and connected to the first surface and the second surface;
a fourth surface, connected to the third surface and the light incident surface and connected to the first surface and the second surface; and
a fifth surface, opposite to the fourth surface, connected to the third surface and the light incident surface and connected to the first surface and the second surface,
wherein the touch module further comprises at least one reflection unit disposed on at least one of the second surface, the third surface, the fourth surface, and the fifth surface.

10. The touch keyboard as claimed in claim 1, wherein the touch module further comprises:
a control unit, electrically connected to the optical detector for determining a position of an object entering the sensing space according to a signal transmitted from the optical detector; and
a memory unit, electrically connected to the control unit, wherein the keyboard pattern has a plurality of key patterns, and the memory unit is capable of storing a position information corresponding to the key patterns, and the control unit is capable of determining the key pattern touched by the object according to the position information.

11. An electronic device, comprising:
a screen, having a display area, wherein the display area is capable of displaying a dynamic image frame;
a base, connected to the screen, and
a touch keyboard, disposed on the base and comprising:
a keyboard pattern, wherein a sensing space is located in front of the keyboard pattern; and
a touch module, disposed at periphery of the keyboard pattern and comprising:
at least one light emitting element, disposed beside the keyboard pattern and capable of emitting a light beam;
at least one light guide unit, disposed at a side of the keyboard pattern and having a first surface, a second surface opposite to the first surface, and a light incident surface connected to the first surface and the second surface, wherein the light beam from the light emitting element is capable of entering the light guide unit through the light incident surface and capable of being transmitted to the sensing space through the first surface; and
at least one optical detector, disposed beside the sensing space for sensing the light beam from the sensing space.

12. The electronic device as claimed in claim 11, wherein the touch keyboard comprises a carrier board, and the carrier board comprises:
a keyboard area, wherein the keyboard pattern is disposed on the keyboard area; and
a notch, disposed at an edge of the keyboard area, wherein the light emitting element and the light guide unit are disposed in the notch.

13. The electronic device as claimed in claim 12, wherein the touch keyboard further comprises a top cover having an opening, wherein the top cover covers the notch, the light emitting element, and the light guide unit, the opening exposes the keyboard pattern, and the carrier board and the top cover are disposed on the base.

14. The electronic device as claimed in claim 11, wherein the touch keyboard comprises a top cover, and the top cover comprises:
an upper surface;
a lower surface, opposite to the upper surface;
a recessed area, disposed on the upper surface, wherein the keyboard pattern is disposed in the recessed area; and
a notch, disposed on the lower surface, wherein the light emitting device and the light guide unit are disposed in the notch, the top cover covers the base, and the lower surface faces to the base.

15. The electronic device as claimed in claim 11, wherein the keyboard pattern is a patterned printed layer.

16. The electronic device as claimed in claim 11, wherein the keyboard pattern is a thin film printed with a pattern.

17. The electronic device as claimed in claim 11, wherein the touch keyboard further comprises a projection module, and the keyboard pattern is an image projected by the projection module.

18. The electronic device as claimed in claim 11, wherein the keyboard pattern is disposed at a position outside the display area.

19. The electronic device as claimed in claim 11, wherein the light guide unit further comprises:
a third surface, opposite to the light incident surface and connected to the first surface and the second surface;
a fourth surface, connected to the third surface and the light incident surface and connected to the first surface and the second surface; and
a fifth surface, opposite to the fourth surface, connected to the third surface and the light incident surface, and connected to the first surface and the second surface,
wherein the touch module further comprises at least one reflection unit disposed on at least one of the second surface, the third surface, the fourth surface, and the fifth surface.

20. The electronic device as claimed in claim 11, wherein the touch module further comprises:
a control unit, electrically connected to the optical detector for determining a position of an object entering the sensing space according to a signal transmitted from the optical detector; and
a memory unit, electrically connected to the control unit, wherein the keyboard pattern has a plurality of key patterns, and the memory unit is capable of storing a position information corresponding to the key patterns, and the control unit is capable of determining the key pattern touched by the object according to the position information.
